(19) United States
(12) Patent Application Publication
(10) Pub. No.: US 2019/0377739 A1
(43) Pub. Date: Dec. 12, 2019

(54) SYSTEMS, METHODS, AND APPARATUSES FOR SOCIAL GIFTING

(71) Applicant: GroupGifting.com, Inc., Huntington, NY (US)

(72) Inventors: David S. Levinsky, Huntington Station, NY (US); Eric C. Manno, Centereach, NY (US); Mark J. Manno, Dix Hills, NY (US); Tyler Roye, Huntington, NY (US)

(21) Appl. No.: 16/518,222

(22) Filed: Jul. 22, 2019

Related U.S. Application Data
(63) Continuation of application No. 14/676,524, filed on Apr. 1, 2015, now abandoned.
Application No. 14/676,524 is a continuation of application No. PCT/US13/63151, filed on Oct. 2, 2013.
(60) Provisional application No. 61/708,885, filed on Oct. 2, 2012.

(51) Int. Cl. G06F 16/2457; G06F 16/951; G06Q 50/00

(52) U.S. Cl. CPC G06F 16/24578; G06Q 50/01; G06F 16/951

(57) ABSTRACT

The systems, methods, and apparatuses of the present disclosure transform unique data characteristics about individual users of social networks into a series of output scores based on predefined rules. Input data is collected from multiple data sources, including social networks, third party sources of information, and internal data sources. The input data is combined to create a profile of an individual. The profile is assigned a score which may be passed to social gifting applications to provide them with a way to reward users with high profile scores that reflect positive gifting activities and to penalize users with low profile scores that reflect negative gifting activities.

### BACKGROUND

### Technical Field

The present disclosure relates to social gifting. More particularly, the present disclosure relates to systems, methods, and apparatuses for scoring members of a social network based on their social gifting activities when using a social gifting application.

### Background of Related Art

Social networks are made up of individuals and organizations. Members of social networks can discuss common interests, provide opinions, share items, communicate privately, or exchange good wishes for various celebratory occasions. Some members of social networks are active and have many friends, while other members are not as active or may not have many friends. Additionally, in some cases, social networks do not efficiently prevent individual users from creating multiple personal accounts, and they do not always validate the profile data of members to confirm their identity.

Social gifting applications are used in conjunction with social networks to facilitate the exchange of gifts between members of a social network. Gifts can be in any form including physical items, gift cards, electronic gift (egift) cards, or virtual gifts. To be successful, social gifting applications induce many members of social networks to use the social gifting application.

Today, there is no effective way to determine which members of a social network are potential active users or “evangelists” that would help grow the usage of a social gifting application. More importantly, because it is difficult to differentiate between a real member and a false persona member of a social network, there is a risk of rewarding users of the social gifting application that are not actually helping to grow usage, but rather are attempting to exploit the social gifting system.

### SUMMARY

The present disclosure, in one aspect, features a system that scores members of a social network based on their social gifting activities when using a social gifting application. The system includes a communication interface, an internal database, a scoring module, and an output reporting module. The communication interface receives user data from an external device and configured to communicate with a social gifting application server to receive information regarding a request from a first user to give a gift to a second user. The internal database communicates with the communication interface and stores the user data. The scoring module determines, based on predetermined rules and the user data, a first user score for the first user and a second user score for the second user, compares the first user score to a first baseline passing score, and compares the second user score to a second baseline passing score. The output reporting module notifies the social gifting application server of a result of the comparisons.

The request to give the gift may be granted if the scoring module determines that the first user score is greater than or equal to the first baseline passing score and the second user score is greater than or equal to the second baseline passing score, but the request to give the gift may be revoked if the scoring module determines that the first user score is less than the first baseline passing score or the second user score is less than the second baseline passing score.

The scoring module may determine a gift score for the gift and compare the gift score to a third baseline passing score. The scoring module may determine the gift score by determining a first difference between the first user score and a first baseline score, determining a second difference between the second user score and a second baseline score, summing the first and second differences to obtain a third difference, and subtracting the third difference from a third baseline score. The request to give the gift may be granted if the scoring module determines that the third user score is greater than or equal to the third baseline passing score but the request to give the gift may be revoked if the scoring module determines that the third user score is less than the third baseline passing score.

The predetermined rules associate positive user data with a positive point value and negative user data with a negative point value based on a user type. The scoring module may determine the first user score by adding the positive or negative point value to a first user baseline score, and may determine the second user score by adding the positive or negative point value to a second user baseline score.

The social gifting application server may host social gifting applications that run on user devices. The external device may be at least one of an external data source server and a social network server. The communication interface may include at least one common object bus that converts user data from the external device into a form that can be used by the system.

The system may include a social gifting rewards engine database that stores the first user score, the second user score, and the gift score. The system may include a system configuration module that allows an operator to set the first and second baseline passing scores.

The system may include a rule configuration module that allows an operator to create rules that associate the stored user data with a positive or negative point value to be added to the first and second user scores.

In another aspect, the present disclosure features a method that includes receiving user data from an external device; communicating with a social gifting application server to receive information regarding a request from a first user to give a gift to a second user; storing data regarding the user data in an internal database; determining, based on predetermined rules and the user data, a first user score for the first user and a second user score for the second user; comparing the first user score to a first baseline passing score, comparing the second user score to a second baseline passing score, and notifying the social gifting application server of a result of the comparisons.

The method may include determining a gift score for the gift and comparing the gift score to a third baseline passing score. The method may include determining a first difference between the first user score and a first baseline score, determining a second difference between the second user score and a second baseline score, summing the first and second differences to obtain a third difference, and determining the gift score by subtracting the third difference from a third baseline score.

In aspects, the request to give the gift may be granted if the third user score is greater than or equal to the third baseline passing score, and the request to give gift is revoked if the third user score is less than the third baseline passing score. The predetermined rules may associate positive user data with a positive point value and negative user data with a negative point value based on a user type.

The first user score may be determined by adding the positive or negative point value to a first user baseline score, and the second user score may be determined by adding the positive or negative point value to a second user baseline score.

In aspects, the social gifting application server may host social gifting applications configured to run on user devices. The external device may be at least one of an external data source server and a social network server.

The method may include storing the first user score, the second user score, and the gift score in a social gifting rewards engine database. The method may include allowing an operator to set the first and second baseline passing scores. The method may include allowing an operator to create rules that associate the stored user data with a positive or negative point value to be added to the first and second user scores.

In yet another aspect, the present disclosure features a system comprising a social gifting application server and a social gifting rewards engine server in communication with the social gifting application server via a network. The social gifting application server is configured to receive a request from a first user to give a gift to a second user. The social gifting rewards engine server includes a communication interface, a scoring module, and an output reporting module. The communication interface receives user data from an external device and communicates with the social gifting application server to receive information regarding the request from the first user to give the gift to the second user. The scoring module determines, based on predetermined rules and the user data, a first user score for the first user and a second user score for the second user, compares the first user score to a first baseline passing score, and compares the second user score to a second baseline passing score. The output reporting module notifies the social gifting application server of a result of the comparisons.

In aspects, the system may include an external device configured to provide user data to the social gifting rewards engine server. The external device may be at least one of an external data source server and a social network server.

### BRIEF DESCRIPTION OF THE DRAWINGS

The present disclosure may be understood by reference to the accompanying drawings, when considered in conjunction with the subsequent, detailed description, in which:

FIG. 1 is a graphical illustration of user types that interact with social gifting systems and that are given profile scores in accordance with various aspects of the present disclosure;

FIG. 2 is a diagram illustrating an exemplary communication network that connects social networks, external data sources, users, and a social gifting rewards system in accordance with various aspects of the present disclosure;

FIG. 3 is a schematic block diagram of the social gifting rewards system illustrating the exchange of data between input data sources, a social gifting rewards system, and social gifting applications in accordance with various aspects of the present disclosure;

FIG. 4 is a block diagram of a computer device used for implementing the social gifting rewards system or user devices that interface with the social gifting rewards system in accordance with various aspects of the present disclosure;

FIG. 5 is a flowchart of a method to set a baseline score for a user, to set a baseline score for giving a gift, to set a baseline score for receiving a gift, and to set a baseline score for a gift in accordance with an aspect of the present disclosure;

FIG. 6 is a flowchart of a methods for establishing scoring rules for various sources of input data in accordance with an aspect of the present disclosure;

FIG. 7 is a flowchart of a method for calculating and assigning a user an adjusted baseline score in accordance with an aspect of the present disclosure; and

FIG. 8 is a flowchart of a method for analyzing scores of the users and the gift in accordance with an aspect of the present disclosure.

### DETAILED DESCRIPTION

A social gifting rewards system generates various types of scores for a gift giver and a gift recipient to differentiate between a real user and a fake user of a social gifting application in a social network. The social gifting rewards system gives positive scores to activities that represent proper use of a social network and gives negative scores to activities that may potentially exploit a social gifting system. The social gifting rewards system differentiates fake accounts created by the same user from real accounts of different users based on the scores assigned to each user and/or each gift. A gift originator or gift giver sends a request to give a gift to a gift recipient. The social gifting rewards system notifies the gift giver that the request for the social gift is granted in a case where any or all of the scores exceed predetermined threshold values. The social gifting rewards system also notifies the gift giver that the request for the social gift is revoked in a case where any or all of the scores do not exceed the predetermined threshold values.

In one scenario, a social gifting application rewards users based on information in the user's personal profile and based on positive gifting activities. The positive gifting activities may include the number of gifts given, the number of friends a person has in a social network, the frequency that a person visits the social gifting application, and the number of friends the user has invited to use the social gifting application.

In another scenario, a social gifting application may penalize a user based on negative gifting activities associated with that user. Negative activities may include creating fake accounts on social networks, sending or attempting to send gifts to the fake accounts, only using an account to receive special promotions from the social gifting application, and never inviting any friends to use the social gifting application.

The social gifting rewards system of the present disclosure calculates various scores that are provided to the social gifting application. The social gifting application uses the calculated scores to determine whether the rewards should be given to a particular user.

The social gifting application retrieves data from one or more data sources including, for example, social networks, third-party services, or internal systems. Rules are configured for the data retrieved from the data sources. These rules instruct the social gifting rewards engine to apply numeric scores to the retrieved data.

The scores can be static or dynamic and can be weighted with multipliers. The rules and scores can apply to any user type and any gift type. The scores may fall into multiple categories including a score for giving gifts, a score for receiving gifts, and an overall score for the gift.

To calculate the scores for giving and receiving gifts, points derived from the data sources are combined with preset baseline scores and then compared to predetermined threshold scores. The difference between the score for giving gifts and its baseline score, and the difference between the score for receiving gifts and its baseline score may be combined to derive a final or total gift score. The final scores may be passed back to the social gifting application so that it can determine how to treat a user, e.g., so that it can determine whether or not to revoke a request to give a gift.

An advantage of the social gifting rewards system is that it provides a social gifting application with information about the positive gifting activity of its users. Social gifting applications may use that information to identify evangelists that promote the use of the social gifting application. These evangelists may be rewarded with the availability of more gifts. They may also be encouraged to further promote use of the social gifting application.

Another advantage of the social gifting rewards system is that it provides a social gifting application with information about the negative gifting activity of its users. Using that information, the social gifting application can prevent users from exploiting the social gifting system, which would result in a more positive experience for other users with positive gifting activity.

Yet another advantage of the social gifting rewards system is that it provides a social gifting application with information about its users that is derived from multiple data sources to better identify the gifting activity of those users. When more information is available, better decisions can be made regarding the treatment of users of the social gifting system.

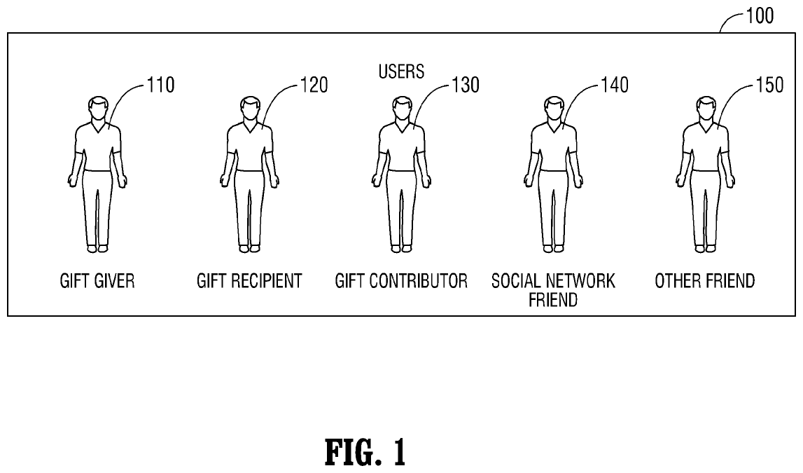

FIG. 1 is a diagram illustrating the types of users that interact with a social gifting system and that are given profile scores in accordance with various aspects of the present disclosure. The user types include a gift giver 110, a gift recipient 120, a gift contributor 130, a social network friend 140, and other friends 150. The gift giver 110 is a user who uses a social gifting application and initiates a request to give a gift to the gift recipient 120. The gift contributor 130 contributes to the gift requested by the gift giver 110 for the gift recipient 120. The social network friend 140 may be a friend of the gift giver 110 or the gift recipient 120 in any social network with which the gift giver 110 or the gift recipient 120 have associations. Other friend 150 is a user who has a relationship with other users 100 but may not be connected to those users 100 via any social network.

When a user, whether inside or outside a social network, wants to celebrate an event (e.g., birthday, anniversary, passing a test, advancement in a company, divorce, death, etc.) for the user's friend or simply wants to give a gift, the user becomes a gift giver 110 and the user's friend becomes a gift recipient 120. The gift giver 110 uses a social gifting application to choose a gift recipient 120 and/or to select a gift for the gift recipient 120. By using the social gifting application, the gift giver 110 may invite friends of the gift giver 110 and/or of the gift recipient 120 to contribute in any way to the gift. The invitation may be sent via emails, text messages, voice messages, video messages, or any other form of electrical communication. Anyone who accepts the invitation and wants to contribute to the gift becomes a gift contributor 130.

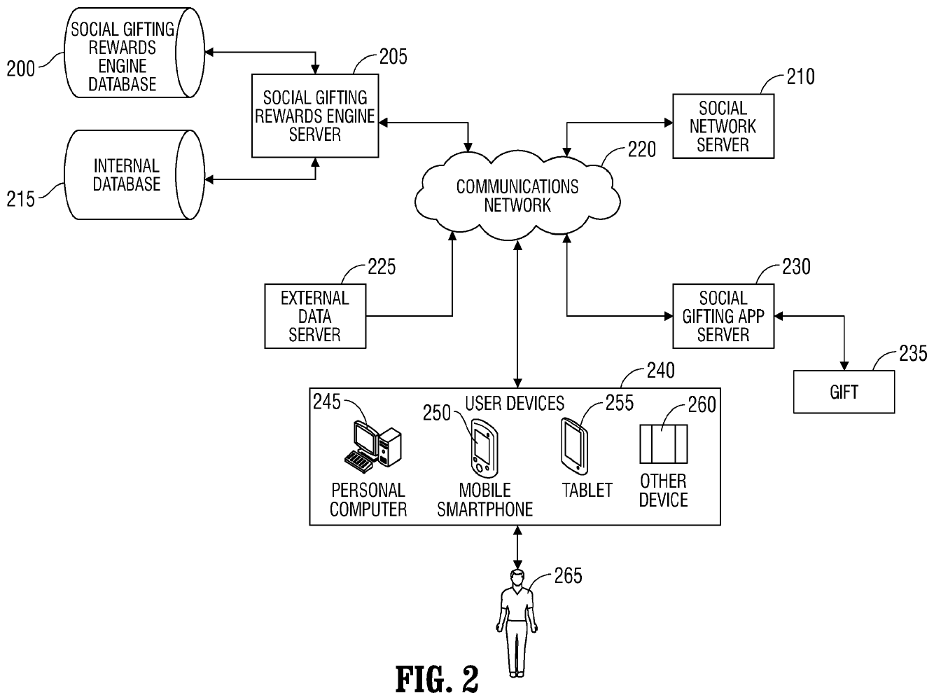

FIG. 2 is a diagram illustrating an exemplary communication network 220 through which a social gifting rewards engine server or system 205 may communicate with social networks 210, external data sources 225, social gifting application servers 230, and user devices 240 in accordance with various aspects of the present disclosure. The social gifting rewards engine server 205 may be in communication with a social gifting rewards database 200 and an internal database 215. The social gifting rewards engine server 205 may be a program or an actual computing device that performs all of features disclosed in the present disclosure. For example, the social gifting rewards engine server 205 includes memory which stores a program, i.e., social gifting rewards engine, which is an application that is executed by the central processing unit (CPU) of the social gifting rewards engine server 205.

The social gifting rewards engine database 200 is an application that is executed by the central processing unit (CPU) of the social gifting rewards engine server 205 and is stored in the memory of the social gifting rewards engine server 205. The internal data of the internal database of the internal database 215 is stored in the memory of the social gifting rewards engine server 205. The internal data of the internal database 215 may include any data about users' activities within the social gifting rewards engine server 205 or any data about users' activities outside of the social gifting rewards engine server 205 that is collected by the social gifting rewards engine server 205. The social gifting rewards engine database 200 provides information to determine, by using the internal data of the internal database 215, whether to grant or revoke a request of a user to give a gift to another user via a social gifting application that communicates with a social gifting application server 230. Internal data of the internal database 215 may be added, updated, modified, or deleted by the social gifting rewards engine server 205.

Social network server 210 is a third party server that provides various information of its users to the social gifting rewards engine server 205 via the communications network 220. For example, a social network server 210 may be Facebook, Twitter, Pinterest, or any other type of community-based server that facilitates interactions between its users. The social network server 210 may have to receive an approval from users to provide users' information to the social gifting rewards engine server 205. In embodiments, when a user wants to give the user's friend a gift and uses a social gifting application running on one of the user devices 240, the user may have to give the social gifting application server 230 an approval via the communication network 220 so that the social gifting application server 230 transmits the approval to a social network server 210 and may collect the user's and friend's information from the social network server 210.

The external data server 225 may provide various information to the social gifting rewards engine server 205 via the communications network 220. For example, the various information may include computer device fingerprints, facial recognition information, geo-coding data, or DNA data which are related to users. The social gifting rewards engine server 205 may use this information to identify a user of an account and to determine whether two or more accounts were created by the same user so that the user could send themselves a gift multiple times. For example, if two accounts were created at the same physical location, the social gifting rewards engine server 205 may identify the two accounts as having been created by the same user by analyzing the geo-data of the two accounts. The social gifting rewards engine server 205 may analyze computer device fingerprints of the two accounts to determine if the two accounts were created by the same computer. The device fingerprints may include but are not limited to user agent, screen height, screen width, screen color depth, time zone offset, session storage usage, local storage usage, plug-ins installed, media access control (MAC) address, and Internet protocol (IP) address.

If two accounts use the same picture of the user, the social gifting rewards engine server 205 may determine that the two accounts were created by the same user by using facial recognition information from the picture of the user. In this way, the social gifting rewards engine server 205 uses external data provided by the external data server 225. The external data server 225 may be any server from which the social gifting rewards engine server 205 may collect information that can be used to identify users.

The social gifting application server 230 hosts social gifting applications through which users can give a gift 235 at any time and can purchase the gift 235 for themselves. When a user uses a social gifting application to give a gift to his/her friend, the social gifting application makes a request for the gift and the social gifting application server 230 sends the request to the social gifting rewards engine server 205. The social gifting rewards engine server 205 collects data related to the gift giver, the gift recipient, and the gift from various external and internal sources, calculates scores for the gift giver, the gift recipient, and/or the gift, and determines whether the scores are passing scores. Depending on whether the scores are passing scores, the social gifting rewards engine server 205 grants or denies the user's request to give a gift. A passing score, which may vary based on pre-defined parameters set in social gifting applications, results in a gift 235 being delivered to gift recipient.

User 265 may access the social network server 210 and the social gifting application server 230 via various user devices 240 including a personal computer 245, a mobile smartphone 250, a tablet 255, or some other computing device 260. User 265 may use a web browser and an application to access the social network server 210 and the social gifting application server 230. By using a web browser, user 265 may provide user specific information to the external data server 225 and to the social network server 210 and, by using a social gifting application, the user 265 may provide user specific information to the social gifting application server 230.

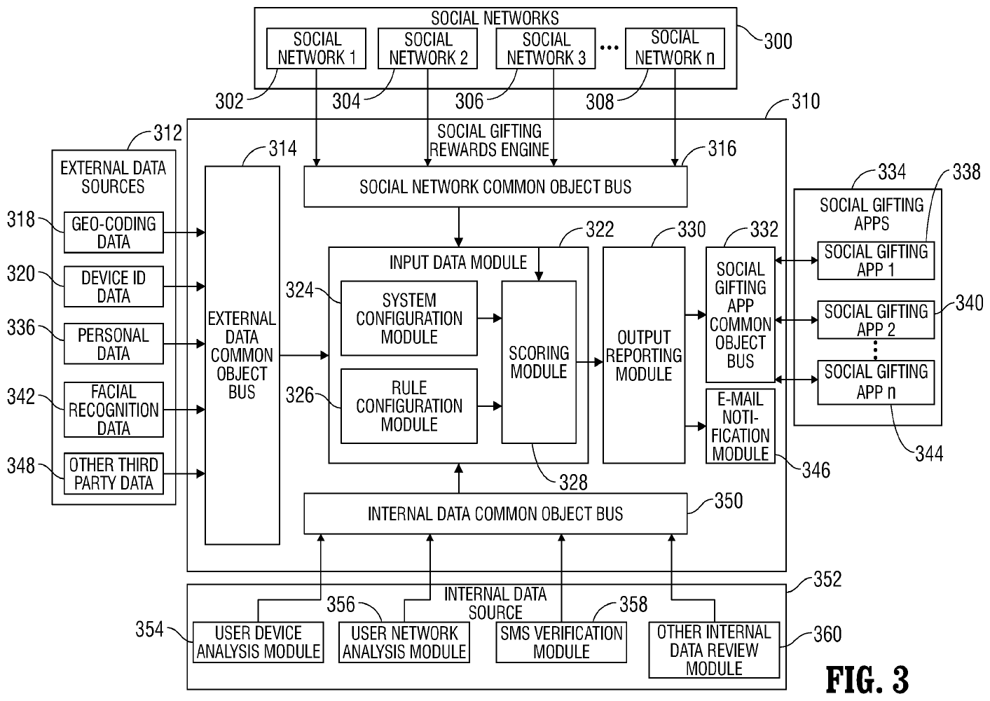

FIG. 3 is a schematic block diagram illustrating a social gifting rewards engine 310 and the exchange of data between data sources, the social gifting rewards engine 310, and social gifting applications 334 in accordance with various aspects of the present disclosure. The social gifting rewards engine 310 communicates with social networks 300, external data sources 312, social gifting applications 334, and an internal data source 352 that receives and collects information that is used by the social gifting rewards engine 310 to grant or revoke a user's request to give a gift to the user's friend.

The social networks 300 are represented by groups of individuals interacting with one another within a particular environment. For example, social network 1 (302) may be Facebook, social network 2 (304) may be Twitter, social network 3 (306) may be Pinterest, and social network n (308) may be any other social network. The social networks 300 gather information about their members and typically share that information as data that is typically accessible via an application program interface. Examples of the information about members of the social networks 300 may include but are not limited to dates of birth, educational background, addresses, marital status, social habits, lists of friends with whom members interact within the social networks 300, web postings that members share, and communications that members make. The social gifting rewards engine server 205 retrieves this information about members of the social networks 300 from the social network servers 210 via the social network common object bus 316 and inputs this information to the social gifting rewards engine 310.

The types of member information that the social networks 302 provide to the social gifting rewards engine 310 may differ depending on the member's preferences. When a member restricts the sharing of their information with a third party, the social gifting rewards engine 310 may retrieve a limited amount of information about the member. In some cases, the member might not be able to use the social gifting application unless the member loosens the restrictions on sharing the member's information with a third party.

The external data sources 312 may be any type of third party data sources that are accessible via an application program interface. The external data sources 312 may include geo-coding data 318 for identifying the location of an individual, device ID data 320 for identifying unique characteristics of a user's device, personal data 336 about an individual that is available via public records, facial recognition data 342, or other third party data 348 such as an individual's deoxyribonucleic acid (DNA) data 440 that can be used to confirm the identity of an individual. The social gifting rewards engine server 205 communicates with the external data server 225 to retrieve information about individuals supplied from the external data sources 312 via the external data common object bus 314.

The social gifting applications 334, which include social gifting applications 1, 2, . . . , n (338, 340, 344), may run on personal computers, mobile devices, or any other type of computing device through which any user can make a request to give a gift to the user's friend and invite others to contribute to the gift. When a user makes such a request by using a social gifting application 338, 340, or 344, the social gifting application server 230 receives the request and transmits it to the social gifting rewards engine server 205 via the social gifting application common object bus 332.

The social gifting rewards engine 310 includes common object buses 314, 316, 332, and 350 through which data is received from and transmitted to other devices on the network, an input data module 322, an output reporting module 330, and e-mail notification module 346. The common object buses 314, 316, 332, and 350 include the external data common object bus 314, the social network common object bus 316, the social gifting application common object bus 332, and the internal data common object bus 350. The common object buses 314, 316, 332, and 350 allow the social gifting rewards engine 310 to communicate with other devices on the network via application program interfaces. Since different social network servers use different formats to communicate, the social network common object bus 316 converts data having one format into another format suitable for the social gifting rewards engine 310. In embodiments, the common object buses 314, 316, 332, and 350 may be integrated into one communication bus with different layers of supporting interfaces.

The input data module 322 includes a system configuration module 324, a rule configuration module 326, and a scoring module 328. The input data module 322 receives data from other internal and external servers via the common object buses 314, 316, and 350, and stores or updates data in memory of the social gifting rewards engine server 205. When a user transmits a request to give a gift, the input data module 316 updates a user's score using data which is related to the user, determines whether to grant or revoke the request, and notifies the user whether the request has been granted or revoked.

The system configuration module 324 is used to manually input baseline parameters that provide a point of comparison for the scoring module 328 as it relates to a scoring scale, user profiles, the act of giving a gift, the act of receiving a gift, and for the gifts themselves. The baseline parameters may include a baseline passing score to give gifts (a first baseline passing score), a baseline passing score to receive gifts (a second baseline passing score), and a baseline passing score for the gifts (a third baseline passing score).

For example, the scoring scale may range from one through ten, where ten is the best score and one is the worst score, and all users may start with a score of ten as a baseline score. The baseline passing score may be six for a gift giver to give a gift to her friend, the baseline passing score may be seven for a gift recipient to receive a gift, and the baseline passing score may be four for a gift to be delivered to the gift recipient. Thus, if a gift giver receives a score of six and a gift recipient receives a score of seven, then the gift could be given by the gift giver and sent to the gift recipient. But, if a first delta or difference between the gift giver score of six and a baseline score of ten (which is equal to four) is combined with a second difference between the gift recipient score of seven and the baseline score of ten (which equals three) to determine a third delta or difference, which would be seven (i.e., four plus three), and if the third delta is subtracted from the baseline gift score of ten, the result would be a gift score of three. Since the gift score of three is less than the baseline passing score of four for gifts to be delivered, then, while a user score greater than five would allow a user to use the social gifting application 334 to make a request to give a gift to a friend and to receive a gift from a friend, a gift score of three or below would not allow the delivery of the gift by the social gifting applications 334.

The rule configuration module 328 defines all data sources and provides the scoring module 328 with parameters regarding input data values, which can be either positive or negative, and how those values should be used by the scoring module 328. The rule configuration module 326 is used to set rules that associate data with a point. Positive activities are assigned positive points while negative activities are assigned negative points. Examples of positive activities may include posting messages to a social network webpage, communicating with friends via the social network server or application, logging into the social network server or application at least once every day or every other day, being an active user for over a year, giving or receiving social gifts, etc. Negative activities may include any activities that exploit a social gifting system including creating false persona accounts so that the user can send multiple gifts to himself. In this way, the rule configuration module 326 rewards positive activities and penalizes exploitation of a social gifting system.

In embodiments, the rule configuration module 326 may have different rules for the same type of data which is received from different data sources. For example, a user's registration date with Facebook more than one year before the current date may be assigned a positive two, while a user's registration date with a recently-organized social network less than six months prior to the current date may be assigned a score of positive one. When a Facebook account was created within the last thirty days, a score of negative one point may be assigned to the registration data. As another example, an additional value of two may be added to a user's score if the user has given or received more than a certain number of gifts using the social gifting applications 334. So if the user has an adjusted baseline score of eight and the user is identified as a user who has received five gifts from the social gifting application 334, two points would be added to the adjusted baseline score. Thus, the rule configuration module 326 can give positive points to actively participating users to promote positive activities.

In embodiments, the rule configuration module 326 further defines a rule to award a user with special offers, discounts, or incentives. For example, a rule may be set to apply a ten dollar discount to a user's next purchase if the user has a user score of nine and has given three gifts and invited ten friends to use the social gifting application.

The scoring module 328 performs several functions. The scoring module 328 analyzes data from many data sources which are related to the gift giver, the gift recipient, and the gift, and assigns the data a point value based on the rules prescribed by the rule configuration module 326. For example, input data indicating that a Facebook account was created within the last two or more days may be assigned a score of negative one, and input data indicating that the IP address of a user device used to communicate with a social gifting application was also used by a different user that already received a low score may be assigned a score of negative four. This analysis may be performed for both the gift giver and the gift recipient.

The scoring module 328 may also aggregate all data values into a single score that can be either positive or negative. For example, the scoring module 328 may add together the score of negative one for the Facebook account creation date and the score of negative four for the IP address and may return a single aggregate score of negative five. Again, this procedure may be performed for both the gift giver and the gift recipient.

Next, the scoring module 328 combines the previously calculated single score with each of the baseline scores defined by the system configuration module 324 to create a user adjusted baseline score. For example, the scoring module 326 may take the baseline score of ten that was established via the system configuration module 324 and add the single score of negative five to obtain a user adjusted baseline score of five. As described above, the user adjusted baseline score can vary depending on the role of the user, e.g., whether the user is a gift giver or gift recipient, and depending on the rules defined by the rule configuration module 326.

The scoring module 328 then calculates a first delta score by comparing the user adjusted baseline score with the baseline score set in the system configuration module 324 for requesting a gift and calculates a second delta score by comparing the user adjusted baseline score with the baseline score set in the system configuration module 324 for receiving a gift. For example, if the baseline score set in the system configuration module 324 for giving a gift is seven for the gift giver and the baseline score set in the system configuration module 324 for receiving a gift is also seven for the gift recipient, then the first and second delta scores are calculated by comparing the baseline scores for requesting a gift and receiving a gift to the user adjusted baseline score of five. In this example, the result would be a score of two for the gift giver and a score of two for the gift recipient. The first and second delta scores, which can be either positive or negative, are then combined and added to the baseline gift score defined by the system configuration module 324 to calculate the gift score. The purpose of the gift score is to add a second, optional level of validation related to a user score.

For example, a user score of the gift giver and a user score for the gift recipient could be passing scores when they stand alone, but when the first and second deltas of the two scores are combined, the gift score may not be a passing score. In the example described above, when the first and second delta scores are combined, the resulting gift score is four, which would not be a passing score when compared to the baseline gift score of five.

The output reporting module 330 receives all adjusted baseline scores for the gift giver 110, the gift recipient 120, and the gift 235. The output reporting module 330 formats the results from the scoring module 328 based on predefined templates and delivers the formatted results to the social gifting applications 334 via the social gifting application common object bus 332. The output reporting module 330 also sends a status to the e-mail notification module 346, which notifies the gift giver of the status of the gift via email.

The social gifting application common object bus 332 converts the data from the output reporting module 330 into data formats that are unique to the various social gifting applications 334. In other words, the social gifting applications 334 may communicate with third-party servers using data formats that are not recognized by or compatible with the social gifting rewards engine server. Thus, the social gifting application common object bus 332 converts data that is received from the various social gifting applications 334 into a form that can be used by the social gifting rewards engine 310, and converts the data that the social gifting rewards engine 310 transmits to the various social gifting applications into a form that is usable by the various social gifting applications. The data output from the social gifting application common object bus 332, which resides on the social gifting rewards engine server 205, is accessed by the social gifting application server 230 that hosts the social gifting applications 334 via an application program interface.

For example, the social gifting application 1 (338) may receive a score of seven for giving a gift, a score of seven for receiving a gift, and a gift score of four. Then, based on the scores set in the rule configuration module, the social gifting application either allows or prevents the giving of a gift, allows or prevents the receiving of a gift, or applies special rewards. For example, a user adjusted baseline score of seven may be required to both give or receive gifts, and because all scores described above fall above the baseline scores, the giving, receiving, and delivery of a gift allowed.

In embodiments, the social gifting rewards engine 310 may determine whether to grant or revoke the request to give a gift to the recipient. In this case, the social gifting rewards engine 310 may provide a result of determining whether to grant or revoke the request to give a gift to a recipient rather than scores, to the social gifting application, which then notifies the gift giver of the result.

The internal data source 352 stores and updates data in the memory, which may be in the form of hard disk, a tape disk, a solid state disk, or any form of storage medium known to those skilled in the art. The internal data source 352 includes a user device analysis module 354, a user network analysis module 356, a social media message (SMS) verification module 358, and an internal data review module 360. The user device analysis module 354 may analyze data which may create a device fingerprint including user agent, screen height, screen width, screen color depth, time zone offset, session storage usage, local storage usage, and plug-ins installed.

Another form of data that is collected by the social gifting application server 230 as users 265 communicate with those servers via user devices 240 is data about the network that users 265 and user devices 240 are using to communicate with the social gifting application server 230. For example, data that is gathered by social gifting application server 230 regarding the network that user devices 240 communicate to the social gifting application server 230, and that is, in turn, transferred to the user network analysis module 356 of the social gifting rewards engine 310, may include network IP address, domain name, and type of network, whether mobile or terrestrial

Another form of user verification may be performed by the SMS verification module 358 which sends an SMS message from the social gifting rewards engine server 205 to a user's mobile phone number that includes a unique code. The user has to enter the unique code into a form that is presented to the user via the social gifting application server 230. The unique code entered by the user is transferred from the social gifting application server to the SMS verification module 358 to confirm the identity of the user.

The internal data review modules 360 may retrieve information of users from an internal database and review and provide relevant information to the input data module 322 via the internal data common object bus 350.

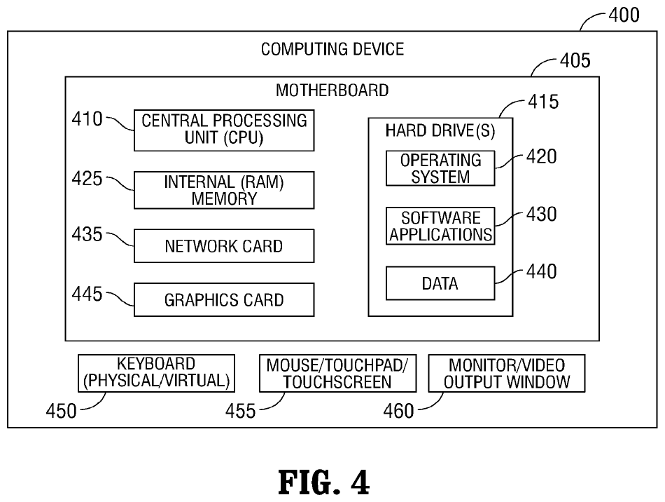

FIG. 4 is a block diagram of a computing device 400 used for servers and user devices in accordance with aspects of the present disclosure. The computing device 400 includes a motherboard 405, a keyboard 450, a pointing device 455, and a display device 460. The motherboard 405 connects internal components of the computing device 400. Hard drive 415 is used for storing programs, which include an operating system 420 and software applications 430, and data 440. Central processing unit (CPU) 410 processes the instructions from the programs stored on the hard drive 415.

The memory 425 is used for temporarily storing various types of information and temporarily making and using information available for quick access. The memory 425 may be a random access memory (RAM) or a read-only memory (ROM). The ROM may have a set of instructions for booting the computing device 400.

The network card 435 connects the computing device 400 to a communications network. The graphics card 445 provides users with a graphical user interface via a display device. The computing device 400 is accessed by users 100 via an access device (e.g., the keyboard 450 either in physical or virtual form), the pointing device 455 (e.g., a mouse or touchpad), and a display device 460 (e.g., a touch screen).

The present disclosure may operate as a software application executed by the computing device 400. The social gifting rewards engine 310 includes a series of instructions written in a computer-executable language that can be executed by the CPU 410. The social gifting rewards engine 310 and all data 440 are stored on the hard disk 415. The social gifting rewards engine 310 may access the RAM 425 for the temporarily stored data or rapid execution of a series of instructions.

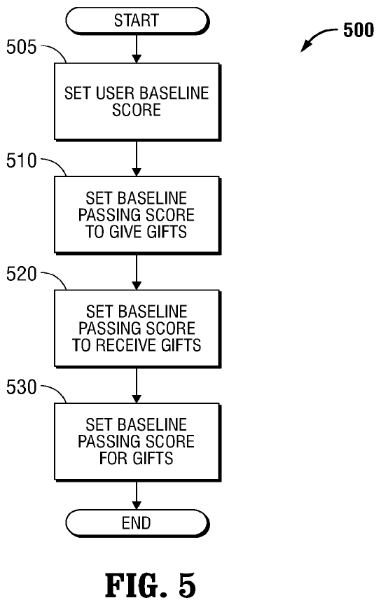

FIG. 5 is a flowchart illustrating a process for setting a user baseline score and baseline passing scores in accordance with aspects of the present disclosure. The user baseline score is set in step 510, the baseline passing score for giving a gift is set in step 520, the baseline score for receiving a gift is set in step 530, and the baseline score for the gift is set in step 540. The baseline score for a user is a starting score when a user first uses the social gifting rewards engine 310, and may be adjusted based on activities that the user performs afterwards or based on data received from external data sources. The baseline passing scores for giving and receiving a gift and for the gift are scores to be compared with the adjusted baseline score to determine whether to grant or revoke a request to give a gift.

The user baseline score and the baseline passing scores may be entered to globally affect all user scores or to affect only particular users based on a social network of which they are members. All settings are defined by the system configuration module 324 of FIG. 3 and may be added to, modified, or deleted. For example, the user baseline score may be set to ten, and the baseline passing score to give gifts, the baseline passing score to receive gifts, and the baseline passing score for gifts may each be set to seven.

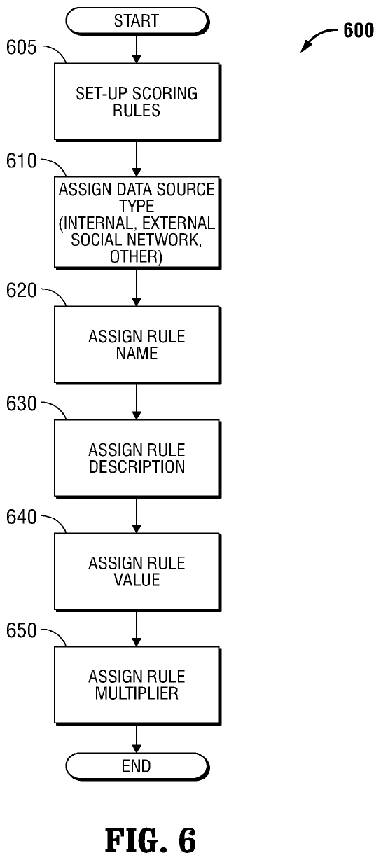

FIG. 6 is a flowchart illustrating a rule configuration method 600 for establishing rules for scoring various sources of data in accordance with an aspect of the present disclosure. The rule configuration module 326 of the social gifting rewards engine 310 generates a series of rules that assign each data item a numerical value. In step 605, scoring rules are set up for all input data to the social gifting rewards engine 310. In step 610, a data source type is assigned. The data source type may be a social network server, a social gifting application server, or an external data source. In other words, scores for the same data item may be dependent upon the source of data. For example, a registration date, which is less than thirty days prior to the current date, may be assigned a score of negative one for Facebook and a score of positive one for other social networks.

In step 620, a unique rule name for each rule is assigned to identify each rule. In step 630, description for each rule is added to the unique rule name. The description may include a brief description of the rule and the reasoning behind why a corresponding numerical value is assigned to the rule.

In step 640, a numeric value is assigned to each data item. This numeric value of each rule may be any value, either positive or negative. Then, in step 650, a rule multiplier is used to increase or decrease the impact a rule value has on a gift score. For example, a scoring rule could be setup for Facebook. A rule which relates to a continuing period after registration may be named Facebook Account Age and a description may be to penalize a user if their Facebook account was created within the last thirty days. The rule value could be set to negative one and the multiplier could be set to one.

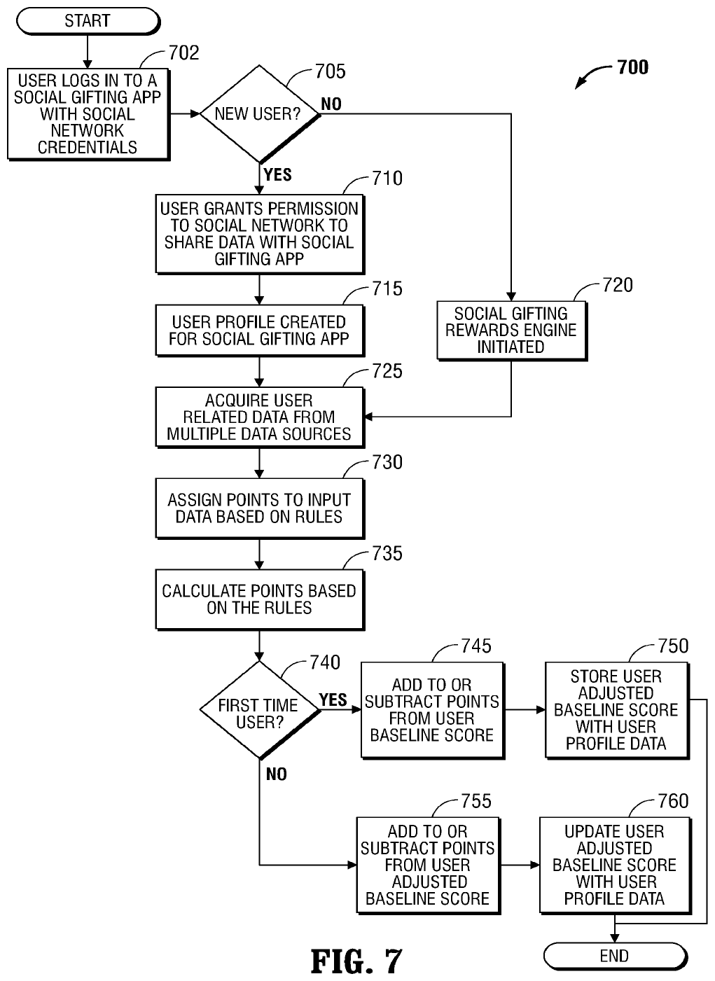

FIG. 7 is a flowchart illustrating a process for calculating and assigning a user adjusted baseline score in accordance with an aspect of the present disclosure. In step 702, the method for determining user adjusted baseline score begins with the user's login to a social gifting application with their social network or non-social network credentials. In step 705, it is determined whether a user is a new user. If it is determined in step 705 that the user is a new user who logs in with their social network credentials, the user is required to first grant permission to the social network to share the user's data with the social gifting application, in step 710. The social gifting application then creates a user profile in step 715. Once the user profile is created, or when an existing user or a user with non-social network credentials logs into the social gifting application, a process is triggered to initiate the social gifting rewards engine in step 720.

The social gifting rewards engine server 205 acquires user-related data from multiple data sources of input data in step 725. The multiple data sources may include social network servers, external data servers, and social gifting application servers. In step 730, the data source triggers the rules previously defined in the rule configuration method. In step 735, the scoring module 328 then calculates points of each input data item or type based on the triggered rules. The points may be positive or negative.

In step 740, it is determined whether a user is a new or existing user to the social gifting application, and then, based on the results of that determination, the user's baseline score is adjusted. In a case where the user is a new user in step 745, the calculated points are added to or subtracted from the user baseline score. In step 750, the result of step 745 is stored with the user profile data. In a case where the user is an existing user in step 755, the calculated points are added to or subtracted from the previously-adjusted user baseline score to update the user adjusted baseline score. In step 760, after the adjusted baseline scores are updated, the updated adjusted user score 760 for the existing user is stored in the social gifting rewards engine database 200 with the user profile data.

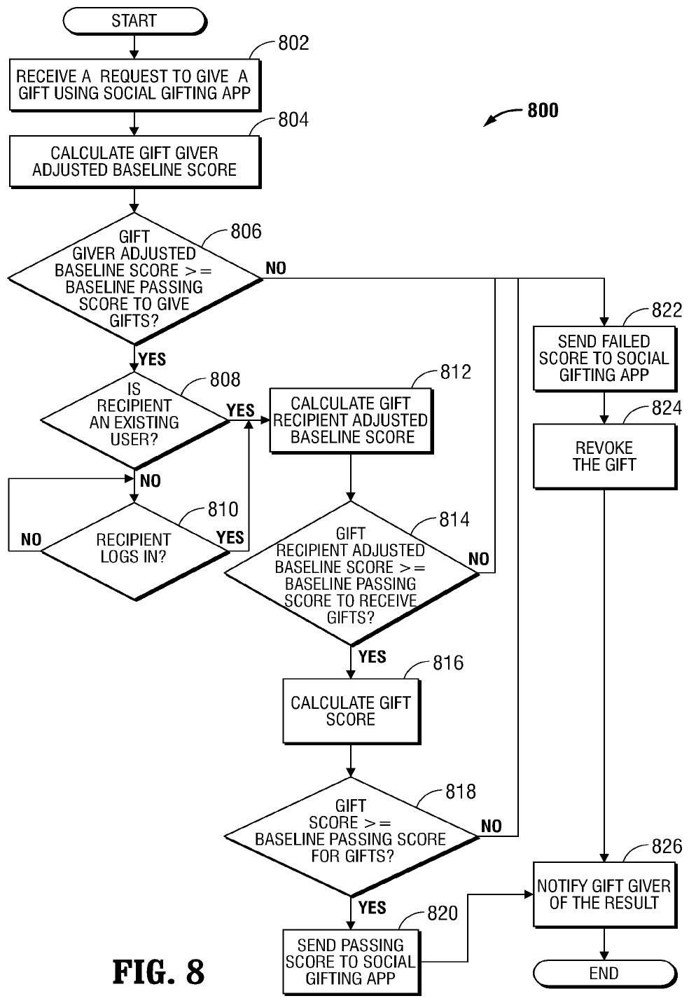

FIG. 8 is a flowchart illustrating a process 800 for calculating and analyzing scores for a gift giver, a gift recipient, and a gift, and passing the scores to a social gifting application in accordance with an aspect of the present disclosure. The process 800 begins with a user's request to send a gift from a social gifting application in step 802, which triggers the social gifting rewards engine 310 to initiate calculation of scores. In step 804, a user adjusted baseline score of the gift giver 110 is read from the user profile residing in the internal data source 352. Then, in step 806, the rule configuration module 326 determines if the user adjusted baseline score exceeds a first baseline passing score, i.e., the baseline score for a gift giver.

For example, if the baseline score for a user is set to ten in the system configuration module 324 and a rule called Facebook Account Age in the rule configuration module 326 is set to negative one if a Facebook account was created within the last thirty days and a user accesses the system with a Facebook account that is only fifteen days old, the data regarding the Facebook account age is sent from the Facebook server to the social gifting rewards engine server 205. The social gifting rewards engine server 205 converts the Facebook account age data into a standardized data format which is analyzed by the scoring module 328.

The scoring module 328 compares the input Facebook data to the threshold set in the Facebook Account Age rule and determines that negative one should be added to the user baseline score, resulting in a user adjusted baseline score of nine for the gift giver 110. The scoring module 328 then checks whether the user adjusted baseline score is a passing score. This is accomplished by comparing the user adjusted baseline score to the baseline passing score for a gift giver in the system configuration module 324. For example, the baseline passing score may be set to seven. Thus, the scoring module 328 would determine, for example, that this particular gift giver has a passing score because the gift giver 110 has a score of nine, which is greater than the baseline passing score for a gift giver.

If the user adjusted baseline score is less than the first baseline passing score, the social gifting rewards engine 310 may send a failed score to a social gifting application in step 822. Alternatively, the social gifting application may send the user adjusted baseline score to a social gifting application, which would perform an action, e.g., revoke a request to give a gift or send such a request to a holding queue to await further review, based on the user adjusted baseline score. If, on the other hand, the user adjusted baseline score is greater than or equal to the first baseline passing score, the social gifting rewards engine 310 checks the gift recipient status in step 808.

In step 808, the process 800 checks whether or not the gift recipient is an existing user of the social gifting application. If it is determined that the gift recipient is not a user or member of the social gifting application, the process 800 continues to check the gift recipient's status until the gift recipient registers with and logs into the social gifting application. Since the social gifting rewards engine 310 is unable to receive the gift recipient's information until the gift recipient becomes a user of the social gifting application and allows the social gifting application 334 to access the gift recipient's information, the social gifting rewards engine 310 waits for the gift recipient to register and login.

In embodiments, the social gifting rewards engine 310 may wait for the gift recipient's registration or login for a predetermined time. If the gift recipient does not register with the social gifting application or does not log into the social gifting application during the predetermined time, the requested gift may be revoked.

If the gift recipient logs into the social gifting application in step 810 or the gift recipient is an existing user of the social gifting application in step 808, then the social gifting rewards engine 310 checks the gift recipient's adjusted baseline score. The gift recipient's adjusted baseline score is then compared to a second baseline passing score in step 814, which is the baseline passing score for the gift recipient set in the system configuration module 324.

The scoring module 328 analyzes user data of the gift recipient to obtain the user adjusted baseline score for the gift recipient, and compares it to a second baseline passing score set in the rule configuration module 326. For example, the user data may indicate that the gift recipient created a Facebook account less than thirty days ago and that the gift recipient has less than twenty-five Facebook friends. The user data item indicating that the gift recipient has created a Facebook account less than thirty days ago may be assigned a value of negative one, which is added to the user baseline score of ten. Also, the user data item indicating that the gift recipient has less than twenty-five Facebook friends may be assigned a value of negative three, which is also added to the user baseline score. Thus, the resulting user adjusted baseline score would be six for the gift recipient of this example. The user adjusted baseline score for the gift recipient may encompass all the data that the social gifting rewards engine 310 receives and collects from external data sources and the internal database of the social gifting rewards engine 310.

If the user adjusted baseline score for the gift recipient is less than the second baseline passing score, the social gifting rewards engine 310 sends a failed score to a social gifting application in step 822. If, in step 814, the user adjusted baseline score is greater than or equal to the second baseline passing score, the process 800 proceeds to step 816.

In step 816, the gift score is calculated when the recipient adjusted baseline score is determined to be greater than or equal to the second baseline passing score in step 814. The gift score is dependent upon the gift giver's adjusted baseline score and the gift recipient's adjusted baseline score.

To calculate the gift score, delta scores of the user adjusted baseline scores for the gift giver and gift recipient are calculated. The delta score for the gift giver is calculated by determining the difference between the user adjusted baseline score for the gift giver and the baseline score for the gift giver set in the system configuration module 324. The delta score for the gift recipient is also calculated by determining the difference between the user adjusted baseline score for the gift recipient and the baseline score for the gift recipient. The delta score may be negative or positive. The gift score is then calculated by adding the two delta scores and adding them to the baseline score for gifts.

In step 818, the gift score is then compared to the third baseline passing score for a gift. If the gift score is less than the third baseline passing score for the gift, steps 822-826 are performed. If the gift score is greater than or equal to the third baseline passing score, then the method proceeds to step 820. In this way, the gift score provides another level of validation related to the user adjusted baseline scores for the gift giver and the gift recipient. In embodiments, the method 800 may not include steps 812 and 814.

In step 820, the social gifting rewards engine 310 sends a passing score to the social gifting application to inform it that the request for the gift can been released to the gift recipient 120. The passing score sent to the social gifting application may merely be a suggestion for the social gifting application to release the gift to the gift recipient. Alternatively, the passing score may cause the social gifting application to automatically release the gift to the gift recipient.

In the case where the user adjusted baseline score for the gift giver is less than the first baseline passing score in step 806, the user adjusted baseline score for the gift recipient is less the second baseline passing score in step 814, and the gift score is less than the third baseline passing score in step 818, the social gifting rewards engine 310 sends a failing score to the social gifting application in step 822. When the social gifting application receives the failing score, the gift is revoked in step 822.

In embodiments, in the case where the social gifting rewards engine sends a failing score to the social gifting application, the social gifting application may perform further processes to determine whether to release the gift despite the failing score. If the failing score is close to the baseline passing score, the request for the gift may be passed to the social gifting application server for further review. For example, if the failing score is six and the corresponding baseline score is seven, the social gifting application may further scrutinize the user data or request the social gifting rewards engine 310 to further analyze the user data.

In the case where the social gifting application determines that the request for the gift is not successful, the gift is revoked in step 824 and the social gifting application notifies the gift giver of the result. If all scores are passing, the social gifting application notifies the gift giver that the request to give a gift has been granted, and, if one of the scores is failing, the social gifting application notifies the gift giver that the request has been revoked via emails, text messages, popup windows, voice messages, or any other communication method known to those skilled in the art. In embodiments, the social gifting rewards engine 310 may notify the gift giver and/or the gift recipient of the result.

Since other modifications and changes may be made to fit particular operating requirements and environments, it is to be understood by one skilled in the art that the present disclosure is not limited to the examples described in the present disclosure and may cover various other changes and modifications which do not depart from the spirit or scope of this disclosure.

What is claimed is:

1. A system comprising:
a communication interface configured to receive user data from an external device and configured to communicate with a social gifting application server to receive information regarding a request from a first user to give a gift to a second user;
an internal database in communication with the communication interface and configured to store the user data;
a scoring module configured to determine, based on predetermined rules and the user data, a first user score for the first user and a second user score for the second user, compare the first user score to a first baseline passing score, and compare the second user score to a second baseline passing score; and
an output reporting module configured to notify the social gifting application server of the results of the scoring module.

2. The system according to claim 1, wherein the request to give the gift is granted if the scoring module determines that the first user score is greater than or equal to the first baseline passing score and the second user score is greater than or equal to the second baseline passing score, and
wherein the request to give the gift is revoked if the scoring module determines that the first user score is less than the first baseline passing score or the second user score is less than the second baseline passing score.

3. The system according to claim 1, wherein the scoring module is further configured to determine a gift score for the gift and compare the gift score to a third baseline passing score.

4. The system according to claim 3, further comprising a social gifting rewards engine database configured to store the first user score, the second user score, and the gift score.

5. The system according to claim 3, wherein the scoring module determines the gift score by determining a first difference between the first user score and a first baseline score, determining a second difference between the second user score and the second baseline score, summing the first and second differences to obtain a third difference, and subtracting the third difference from a third baseline score.

6. The system according to claim 3, wherein the request to give the gift is granted if the scoring module determines that the gift score is greater than or equal to the third baseline passing score, and
wherein the request to give the gift is revoked if the scoring module determines that the gift score is less than the third baseline passing score.

7. The system according to claim 1, wherein the predetermined rules associate positive user data with a positive point value and negative user data with a negative point value based on a user type.

8. The system according to claim 7, wherein the scoring module determines the first user score by adding the positive or negative point value to a first user baseline score, and
wherein the scoring module determines the second user score by adding the positive or negative point value to a second user baseline score.

9. The system according to claim 1, wherein the social gifting application server hosts social gifting applications configured to run on user devices.

10. The system according to claim 1, wherein the external device is at least one of an external data source server and a social network server.

11. The system according to claim 1, wherein the communication interface includes at least one common object configured to convert user data from the external device into a form usable by the system.

12. The system according to claim 1, further comprising a system configuration module configured to allow an operator to set the first and second baseline passing scores.

13. The system according to claim 1, further comprising a rule configuration module configured to allow an operator to create rules that associate the stored user data with a positive or negative point value to be added to the first and second user scores.

14. A method comprising:
receiving user data from an external device;
communicating with a social gifting application server to receive information regarding a request from a first user to give a gift to a second user;
storing data regarding the user data in an internal database;
determining, based on predetermined rules and the user data, a first user score for the first user and a second user score for the second user;
comparing the first user score to a first baseline passing score;
comparing the second user score to a second baseline passing score; and
notifying the social gifting application server of the results of the comparing steps.

15. The method according to claim 14, wherein the request to give the gift is granted when it is determined that the first user score is greater than or equal to the first baseline passing score and the second user score is greater than or equal to the second baseline passing score, and wherein the request to give the gift is revoked when it is determined that the first user score is less than the first baseline passing score or the second user score is less than the second baseline passing score.

16. The method according to claim 14, further comprising:
determining a gift score for the gift; and
comparing the gift score to a third baseline passing score.

17. The method according to claim 16, further comprising storing the first user score, the second user score, and the gift score in a social gifting rewards engine database.

18. The method according to claim 16, wherein determining the gift score includes:
determining a first difference between the first user score and a first baseline score;
determining a second difference between the second user score and a second baseline score;
summing the first and second differences to obtain a third difference; and
subtracting the third difference from a third baseline score.

19. The method according to claim 16, wherein the request to give the gift is granted if the gift score is greater than or equal to the third baseline passing score, and
wherein the request to give gift is revoked if the gift score is less than the third baseline passing score.

20. The method according to claim 14, wherein the predetermined rules associate positive user data with a positive point value and negative user data with a negative point value based on a user type.

21. The method according to claim 20, wherein the first user score is determined by adding the positive or negative point value to a first user baseline score, and
wherein the second user score is determined by adding the positive or negative point value to a second user baseline score.

22. The method according to claim 14, wherein the social gifting application server hosts social gifting applications configured to run on user devices.

23. The method according to claim 14, wherein the external device is at least one of an external data source server and a social network server.

24. The method according to claim 14, further comprising allowing an operator to set the first and second baseline passing scores.

25. The method according to claim 14, further comprising allowing an operator to create rules that associate the stored user data with a positive or negative point value to be added to the first and second user scores.

26. A system comprising:
a social gifting application server configured to receive a request from a first user to give a gift to a second user; and
a social gifting rewards engine server in communication with the social gifting application server via a network, the social gifting rewards engine server including:
a communication interface configured to receive user data from an external device and configured to communicate with the social gifting application server to receive information regarding the request from the first user to give the gift to the second user;
a scoring module configured to determine, based on predetermined rules and the user data, a first user score for the first user and a second user score for the second user, compare the first user score to a first baseline passing score, and compare the second user score to a second baseline passing score; and
an output reporting module configured to notify the social gifting application of the results of the scoring module.

27. The system according to claim 26, further comprising an external device configured to provide user data to the social gifting rewards server.

28. The system according to claim 27, wherein the external device is at least one of an external data source server and a social network server.
